(19) United States
(12) Patent Application Publication
(10) Pub. No.: US 2012/0062468 A1
(43) Pub. Date: Mar. 15, 2012

(54) Method of modifying an interface of a handheld device and related multimedia system

(76) Inventors: Yu-Jen Chen, Taipei County (TW); Yuan-Hsi Tsai, Taipei County (TW)

(21) Appl. No.: 12/879,014

(22) Filed: Sep. 10, 2010

(51) Int. Cl. G06F 3/041; G05B 19/02

(52) U.S. Cl. 345/173

(57) ABSTRACT

A method of modifying an interface of a handheld device includes the handheld device sending an interface request to a device, the handheld device receiving an interface profile from the device in response to the interface request, the handheld device modifying the interface to a modified interface according to the interface profile, and the handheld device controlling the device through the modified interface.

### BACKGROUND OF THE INVENTION

1. Field of the Invention

The present invention relates to a method of modifying an interface and a system, and more particularly to a method of modifying an interface of a handheld device and related multimedia system.

2. Description of the Prior Art

A remote controller allows a user to control an electronic device remotely by transmitting control signals selected by the user to the electronic device. The remote controller may communicate with the electronic device through a wired or wireless connection, the latter being the more popular and flexible option. The remote control may include multiple physical buttons corresponding to functions of the electronic device. For example, if the electronic device is a television set or set-top box, the remote controller may include a power button, multiple numeric buttons, a volume button, and a menu button. The power button may be used for turning the electronic device on and off. The numeric buttons may be used for changing a channel of the electronic device. The volume button may be used for increasing/decreasing speaker volume of the electronic device. The menu button may be used for opening a menu for changing settings of the electronic device, such as brightness, contrast, and other display settings. Traditionally, remote controllers have adopted infrared as a transmission medium for transmitting the control signals to electronic devices. Modern universal remote controllers may include an infrared-to-Bluetooth converter for pairing with Bluetooth-enabled electronic devices.

Handheld devices, such as personal digital assistants (PDAs), mobile phones, and smart phones have increased in functionality to make the handheld devices suitable for performing remote control functions. Many handheld devices now include wireless transceivers for establishing data connections with other electronic devices, either directly or through a wireless network hub, such as a router. For example, a mobile phone may include a Bluetooth transceiver, and a smart phone may include both a Bluetooth transceiver and a wireless network transceiver, such as an IEEE 802.11-series transceiver. Although mobile phones and smart phones provide remote control functions for controlling a personal computer, such functions are limited, inflexible, and insufficient for controlling a television set or set-top box.

### SUMMARY OF THE INVENTION

According to an embodiment, a method of modifying an interface of a handheld device comprises the handheld device sending an interface request to a device, the handheld device receiving an interface profile from the device, the handheld device modifying the interface to a modified interface according to the interface profile, and the handheld device controlling the device through the modified interface.

According to another embodiment, a multimedia system comprises a multimedia device and a handheld device. The multimedia system comprises a display for displaying image data, a network interface module, a receiver module for receiving a control signal for triggering a function of the multimedia device, a transmitter module for transmitting a device profile, and a processor coupled to the display, the network interface module, the receiver module, and the transmitter module for controlling the display according to the function triggered according to the control signal. The handheld device comprises a control interface, a network interface module for establishing a data connection with the network interface module of the multimedia device, a transmitter module for transmitting an interface request to the multimedia device, a receiver module for receiving an interface profile from the multimedia device, and a processor coupled to the control interface, the network interface module, the transmitter module, and the receiver module of the handheld device for modifying the control interface according to the interface profile, and for sending the control signal to the multimedia device according to the interface profile.

According to another embodiment, a method of modifying an interface of a handheld device comprises the handheld device sending an interface request to an online store, the handheld device receiving an interface profile from the online store in response to the interface request, the handheld device modifying the interface to a modified interface according to the interface profile, and the handheld device controlling a device through the modified interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multimedia system according to an embodiment.

FIG. 2 is a flowchart of a method of modifying an interface of a handheld device according to an embodiment.

FIG. 3 is a diagram of a handheld device with a programmable control interface.

FIG. 4 is a block diagram of a multimedia system according to an embodiment.

FIG. 5 is a flowchart of a method of modifying an interface of a handheld device according to another embodiment.

### DETAILED DESCRIPTION

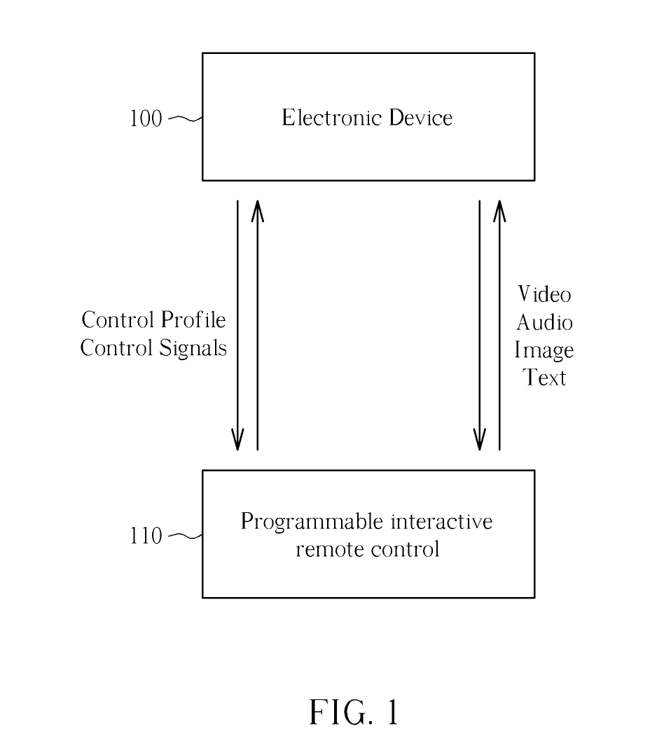

Please refer to FIG. 1, which is a diagram of a multimedia system 10 according to an embodiment. The multimedia system 10 comprises at least an electronic device 100 and a handheld device 110. The electronic device 100 may be a television set, a digital video disc (DVD) player, Blu-ray Disc (BD) player, a game console, or a set-top box. The handheld device 110 may be a remote control device, a mobile phone, or a smart phone. The handheld device 110 may comprise a touch screen. The handheld device 110 may receive a control profile from the electronic device 100, and may receive video, audio, image, vibration, and/or text data over a data connection established between the handheld device 110 and the electronic device 100. The handheld device 110 may output the image, audio, video, vibration, and/or text data received from the electronic device 100. The handheld device 110 may also transmit control signals to the electronic device 100. The control profile and the control signals may be transmitted/received through infrared rays, Bluetooth or wireless network communication, such as Wi-Fi. The control profile and the control signals may also be transmitted/received through the data connection. The text data may also be transmitted/received through infrared rays, Bluetooth or wireless network communication, such as Wi-Fi.

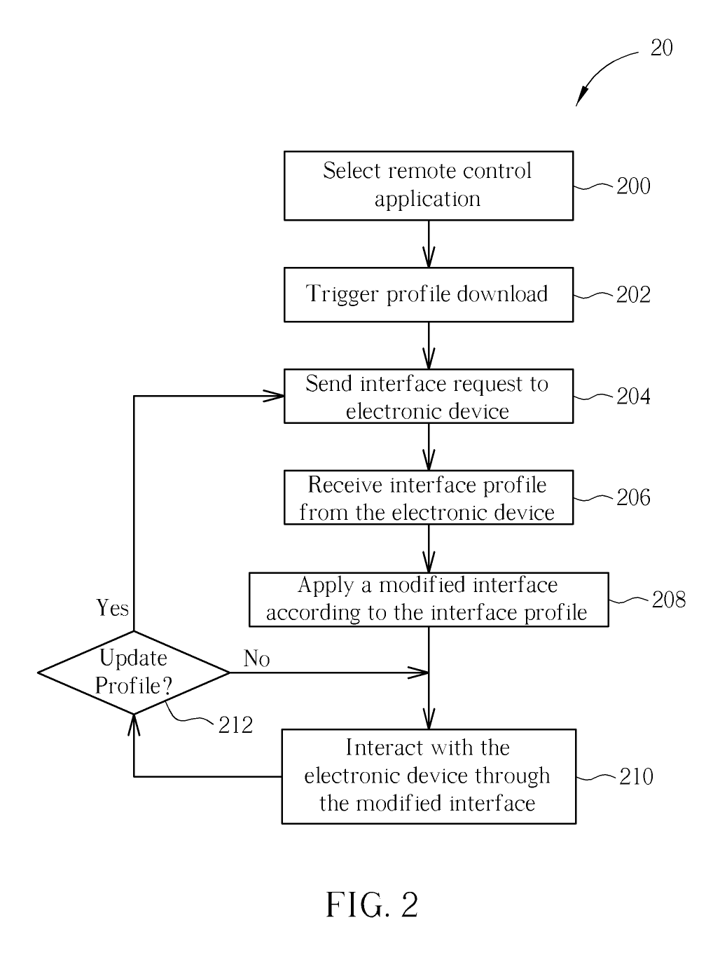

Please refer to FIG. 2, which is a flowchart of a process 20 for modifying an interface of a handheld device, such as the handheld device 110 of FIG. 1, according to an embodiment. The process 20 may be executed in the handheld device, and comprises the following steps:

Step 200: Select remote control application;

Step 202: Trigger download of an interface profile;

Step 204: Send an interface profile request to the electronic device;

Step 206: Receive an interface profile from the electronic device;

Step 208: Apply a modified interface according to the interface profile;

Step 210: Interact with the electronic device through the modified interface; and

Step 212: If profile update is triggered, go to Step 204; else, go to Step 210.

In Step 200, a remote control application is selected. For a smart phone or PDA, which normally may not function as a remote controller, the remote control application may be selected for providing a remote control interface that may run on the smart phone or PDA. For a traditional remote controller, such as a universal remote, Step 200 may be optional.

While the handheld device 110 is operating in a remote control mode, download of an interface profile may be triggered in the handheld device 110 (Step 202). The download operation may be triggered by a button press (hardware or software) or by voice activation.

Based on the trigger, such as the button press or reception of a voice command, the handheld device 110 sends an interface profile request to the electronic device 100 (Step 204). The interface profile request may be sent as an infrared binary code, or may be packetized and sent to the electronic device 100 through the data connection in packet form, such as wireless network communication. The electronic device 100 then sends an interface profile to the handheld device 110.

The handheld device 110 may receive the interface profile from the electronic device 100 (Step 206) through infrared or through the data connection. The interface profile may comprise at least one screen layout and remote control behavior information. The screen layout may be an image comprising a plurality of icons representing software buttons. For a handheld device without a screen, the at least one screen layout may be optional. The behavior information may comprise function definitions for a plurality of control functions for controlling the electronic device 100. The behavior information may also comprise mappings between the plurality of icons of the screen layout and the plurality of control functions. For a handheld device without a touch screen, the mappings may be between the plurality of control functions and a plurality of physical buttons of the handheld device. The behavior information may also comprise a plurality of control signal codes for controlling the electronic device 100 through infrared or wireless network communication. Each control signal code may be a sequence of binary bits corresponding to a predetermined function of the electronic device 100. The behavior information may also define press down, press release, drag, double press, and/or multitouch operations for each icon of the screen layout and/or of each physical button of the handheld device. The behavior information may also comprise voice activation phrase mappings for mapping functions of the handheld device 110 to voice commands.

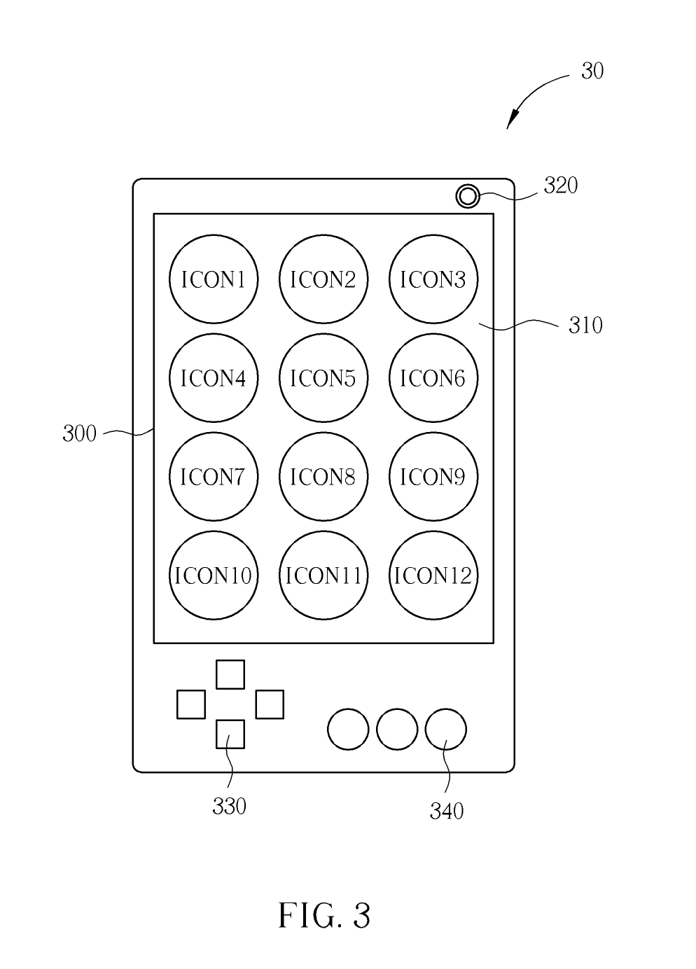

A modified interface is then applied to the handheld device 110 according to the interface profile (Step 208). The screen layout may be displayed in a display of the handheld device 110. The behavior information may be applied to a processor installed in the handheld device 110 for interpreting touch control of each pixel of a touch screen overlaying the display, for interpreting button presses of each physical button of the handheld device 110, and/or for interpreting voice commands. As shown in FIG. 3, a handheld device 30 may comprise a housing 300, and a display 310, a speaker 320, a control pad 330, and a plurality of buttons 340 positioned in the housing 300. According to the process 20, a plurality of icons ICON1-ICON12 may be displayed in the display 310 of the handheld device 30. The plurality of icons ICON1-ICON12 may be arranged in a grid as shown. The plurality of icons ICON1-ICON12 may be arranged in different formations, without limitation herein. Shape of each icon is also not limited herein, with circular, ovular, square, or other combinations thereof all available for use in the display 310. The icons may have uniform size, or some icons may be larger or smaller than other icons. Number of icons is also not limited herein.

Using the modified interface, the handheld device 110 may interact with the electronic device 100 (Step 210). A user may touch the touch screen, may press a physical button, and/or may use a voice command to perform various functions for controlling the electronic device 100. For example, the user may touch a region of the touch screen overlapping a volume up icon displayed in the display, the handheld device 110 may map the touch to a volume up control signal, and may transmit the volume up control signal to the electronic device 100 through infrared or through the data connection. The user may also select another screen layout. The handheld device 110 may then apply the another screen layout by displaying the another screen layout and mapping different functions to icons displayed in the another screen layout.

The process 20 also allows for updating the interface profile, as shown in FIG. 2. The user may touch a region of the touch screen, press a physical button, or may utilize a voice command corresponding to an update interface profile function as part of interacting with the electronic device through the modified interface (Step 210). Upon activating the update interface profile function (Step 212), the handheld device 110 sends anew interface request to the electronic device 100 to receive an updated interface profile or a patch file for modifying part of the interface profile currently in use. The patch file may include new mappings and/or a new screen layout.

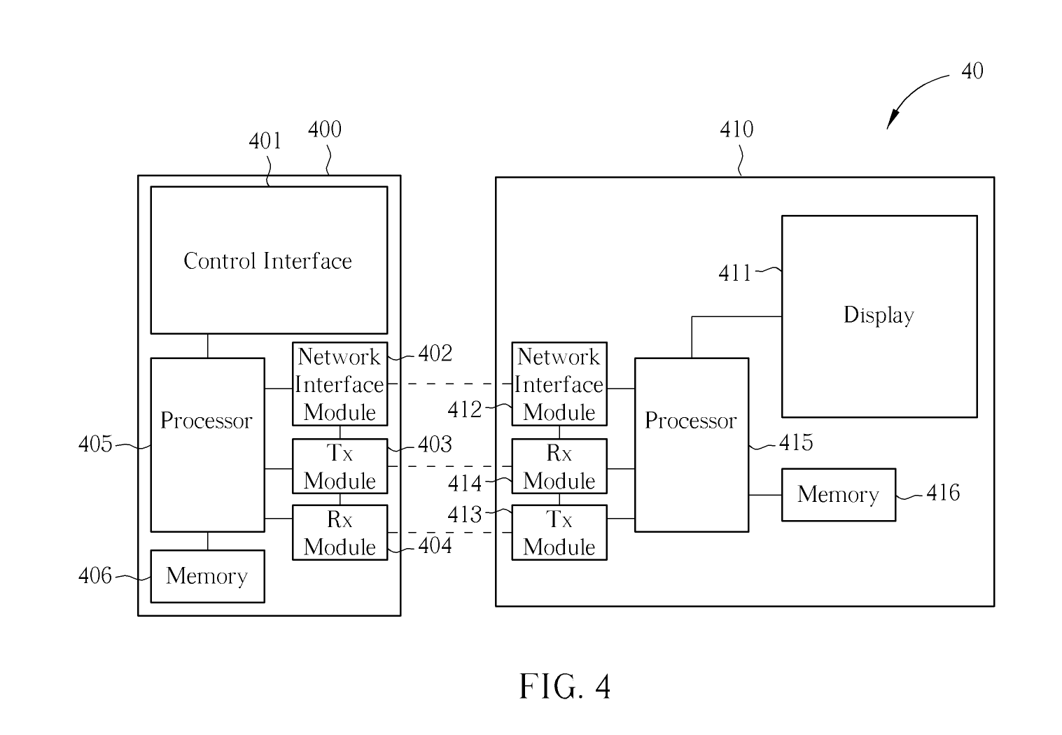

Please refer to FIG. 4, which is a block diagram of a multimedia system 40 according to an embodiment. The multimedia system 40 comprises a handheld device 400 and an electronic device 410. The electronic device 410 may be a multimedia device, such as a television set, set-top box, game console, or optical disc player. The electronic device 410 comprises a display 411, a network interface module 412, a transmitter module 413, a receiver module 414, a processor 415, and a memory 416. The display 411 is utilized for displaying image data, and may be external in the case of a set-top box, game console, or optical disc player. The receiver module 414 is configured for receiving control signals for triggering functions of the electronic device 410. The transmitter module 413 is configured for transmitting an interface profile. The processor 415 is coupled to the display 411, the network interface module 412, the transmitter module 413, the receiver module 414, and the memory 416, and is configured for controlling the display according to the function triggered according to the control signal. The handheld device 400 comprises a control interface 401, a network interface module 402, a transmitter module 403, a receiver module 404, a processor 405, and a memory 406. The control interface 401 may comprise a touch screen, buttons, a track pad, a slider, a dial, and/or a jog for receiving user input. The network interface module 402 may establish a data connection with the network interface module 412. The network interface module 402 of the handheld device may be configured for receiving image, audio, video, and/or text data from the electronic device 410. The transmitter module 403 may be configured to transmit an interface request to the receiver module 414. The transmitter module 403 may transmit the interface request to the receiver module 414 in packet form. The receiver module 404 may be configured to receive the interface profile from the transmitter module 413. The processor 405 is configured for modifying display and/or behavior of the control interface 401 according to the interface profile, and for sending the control signal to the multimedia device according to the interface profile. The processor 405 may modify an interface displayed in the touch screen of the control interface 401 according to a screen layout of the interface profile. The memory 406 may store program code for performing the steps of the process 20. The processor 405 reads the program code to control the control interface 401, the network interface module 402, the transmitter module 403, and the receiver module 404. The memory 406 may also store the interface profile received from the transmitter module 413. The processor 405 of the handheld device may also be configured for controlling the display and/or a speaker of the handheld device 400 to output the image, audio, video, and/or text data received from the device.

Regarding the image, audio, video, vibration, and/or text data received by the handheld device 400, many applications are provided for use in the multimedia system 40. For example, for interacting with a game console, an interactive map image may be received by the handheld device 400 from the game console (the electronic device 410). For interacting with a television set, the handheld device 400 may be utilized to provide video teleconferencing functions in conjunction with the television set (the electronic device 410). For example, the handheld device may be configured for receiving a telephone number input and an activate dialing signal, the television set may display a video stream of a remote user, and the handheld device may be configured for receiving a hang up signal for hanging up the video conference. Another example is a photo slideshow displayed in the television set through a multimedia device, such as the game console or an optical disc player. The handheld device may be configured for displaying an interactive grid of photo thumbnails. When the user selects one of the photo thumbnails, the handheld device may send a control signal to the game console or optical disc player for displaying an image corresponding to the selected photo thumbnail on a connected monitor, such as a television set.

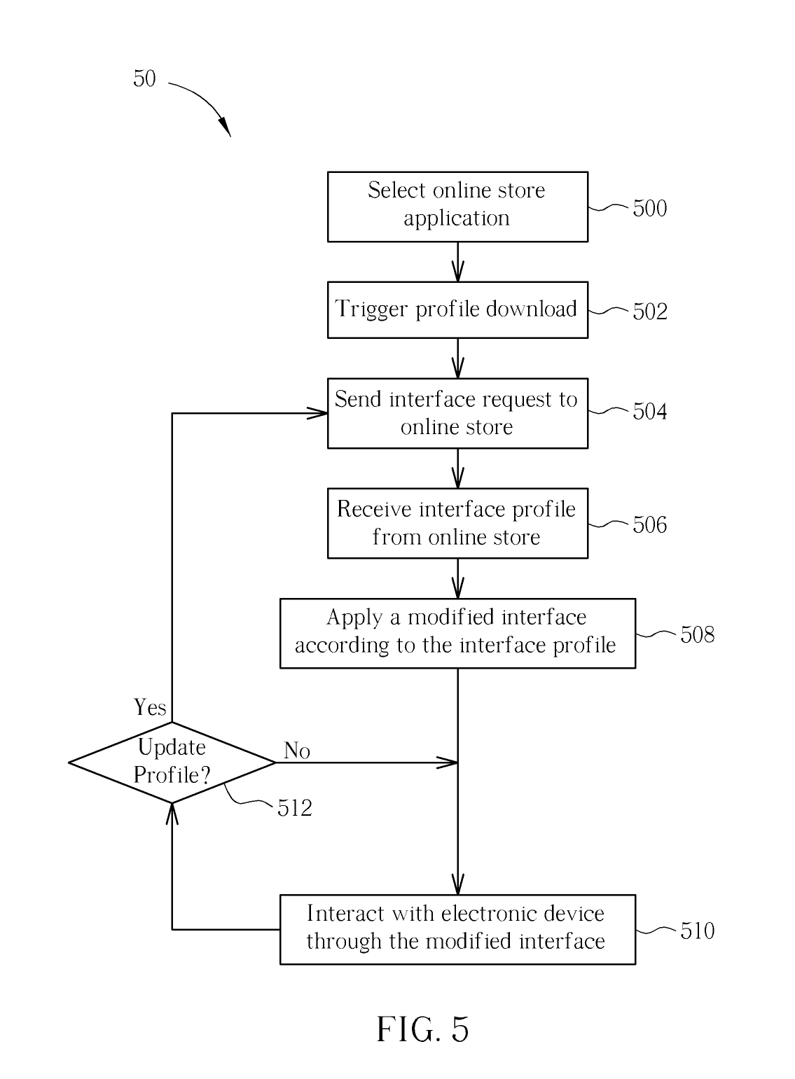

Please refer to FIG. 5, which is a flowchart of a process 50 for modifying an interface of a handheld device, such as the handheld device 110 of FIG. 1, according to an embodiment. The process 50 may be executed in the handheld device, and comprises the following steps:

Step 500: Select online store application;

Step 502: Trigger download of an interface profile;

Step 504: Send an interface profile request to the online store;

Step 506: Receive an interface profile from the online store;

Step 508: Apply a modified interface according to the interface profile;

Step 510: Interact with the electronic device through the modified interface; and

Step 512: If profile update is triggered, go to Step 504; else, go to Step 510.

In Step 500, an online store application is selected. For a smart phone or PDA, which normally may not function as a remote controller, the online store application may be selected for providing a remote control interface that may run on the smart phone or PDA. For a traditional remote controller, such as a universal remote, Step 500 may be optional. Step 500 may be completed in the handheld device. Step 500 may also be completed in a personal computer.

While the handheld device 110 is accessing the online store, download of an interface profile may be triggered in the handheld device 110 (Step 502). The download operation may be triggered by a button press (hardware or software) or by voice activation.

Based on the trigger, such as the button press or reception of a voice command, the handheld device 110 sends an interface profile request to the online store (Step 504). The interface profile request may be packetized and sent to the online store through a data connection in packet form. The online store then sends an interface profile to the handheld device 110.

The handheld device 110 may receive the interface profile from the online store (Step 506) through the data connection. The interface profile may be similar to the interface profile described above for process 20 shown in FIG. 2. A modified interface is then applied to the handheld device 110 according to the interface profile (Step 508). Step 508 is the same as Step 208 shown in FIG. 2. Using the modified interface, the handheld device 110 may interact with the electronic device 100 (Step 510). A user may touch the touch screen, may press a physical button, and/or may use a voice command to perform various functions for controlling the electronic device 100. For example, the user may touch a region of the touch screen overlapping a volume up icon displayed in the display, the handheld device 110 may map the touch to a volume up control signal, and may transmit the volume up control signal to the electronic device 100 through infrared or through the data connection. The user may also select another screen layout. The handheld device 110 may then apply the another screen layout by displaying the another screen layout and mapping different functions to icons displayed in the another screen layout.

The process 50 also allows for updating the interface profile, as shown in FIG. 5. The user may touch a region of the touch screen, press a physical button, or may utilize a voice command corresponding to an update interface profile function as part of interacting with the electronic device through the modified interface (Step 510). Upon activating the update interface profile function (Step 512), the handheld device 110 sends anew interface request to the electronic device 100 to receive an updated interface profile or a patch file for modifying part of the interface profile currently in use. The patch file may include new mappings and/or a new screen layout.

The control signals of the handheld device 110 may include rotational orientation and translation acceleration signals. If the handheld device 110 utilizes an interface profile corresponding to a game console, the interface profile may provide conversion from native format of the orientation and acceleration signals to a game console format compatible with the game console, so that the handheld device 110 may be utilized to control the game console through use of the interface profile. The orientation and acceleration signals are not limited to use with the game console, and may also be applied to any other type of electronic device 100 that the handheld device 110 interacts with through the interface profile.

The processes 20, 50 and the multimedia systems 10, 40 provide a programmable interactive remote control for interacting with an electronic device. The handheld device, by downloading the interactive profile from the electronic device or the online store, is able to interact with any electronic device from any manufacturer, providing great flexibility and convenience of use. Addition of interactive output of audio, image, video, vibration, and/or text in the handheld device further enhances the user experience.

Those skilled in the art will readily observe that numerous modifications and alterations of the device and method may be made while retaining the teachings of the invention.

What is claimed is:

1. A method of modifying an interface of a handheld device, the method comprising:
the handheld device sending an interface request to a device;
the handheld device receiving an interface profile from the device in response to the interface request;
the handheld device modifying the interface to a modified interface according to the interface profile; and
the handheld device controlling the device through the modified interface.

2. The method of claim 1, wherein the handheld device receiving the interface profile from the device comprises the handheld device receiving a screen layout from the device.

3. The method of claim 2, wherein the handheld device modifying the interface to the modified interface according to the interface provide comprises the handheld device displaying the screen layout.

4. The method of claim 1, wherein the handheld device receiving the interface profile from the device comprises the handheld device receiving handheld device behavior information from the device.

5. The method of claim 4, wherein the handheld device modifying the interface to the modified interface according to the interface provide comprises the handheld device changing behavior of the handheld device according to the handheld device behavior information.

6. A multimedia system comprising:
a multimedia device comprising:
a display for displaying image data;
a network interface module;
a receiver module for receiving a control signal for triggering a function of the multimedia device;
a transmitter module for transmitting a device profile; and
a processor coupled to the display, the network interface module, the receiver module, and the transmitter module for controlling the display according to the function triggered according to the control signal; and
a handheld device comprising:
a control interface;
a network interface module for establishing a data connection with the network interface module of the multimedia device;
a transmitter module for transmitting an interface request to the multimedia device;
a receiver module for receiving an interface profile from the multimedia device; and
a processor coupled to the control interface, the network interface module, the transmitter module, and the receiver module of the handheld device for modifying the control interface according to the interface profile, and for sending the control signal to the multimedia device according to the interface profile.

7. The multimedia system of claim 6, wherein the control interface comprises a touch screen, and the interface profile comprises a screen layout.

8. The multimedia system of claim 7, wherein the processor of the handheld device modifies an interface displayed in the touch screen of the control interface according to the screen layout.

9. The multimedia system of claim 6, wherein the interface profile comprises handheld device behavior information.

10. The multimedia system of claim 9, wherein behavior of the control interface is modified according to the handheld device behavior information.

11. The multimedia system of claim 6, wherein the handheld device receives user input through the control interface, and the handheld device sends the control signal to the device according to the user input.

12. A method of modifying an interface of a handheld device, the method comprising:
the handheld device sending an interface request to an online store;
the handheld device receiving an interface profile from the online store in response to the interface request;
the handheld device modifying the interface to a modified interface according to the interface profile; and
the handheld device controlling a device through the modified interface.

13. The method of claim 12, wherein the handheld device receiving the interface profile from the online store comprises the handheld device receiving a screen layout from the online store.

14. The method of claim 13, wherein the handheld device modifying the interface to the modified interface according to the interface provide comprises the handheld device displaying the screen layout.

15. The method of claim 12, wherein the handheld device receiving the interface profile from the online store comprises the handheld device receiving handheld device behavior information from the online store.

16. The method of claim 15, wherein the handheld device modifying the interface to the modified interface according to the interface provide comprises the handheld device changing behavior of the handheld device according to the handheld device behavior information.

17. The method of claim 12, wherein the handheld device controlling the device through the modified interface comprises:
the handheld device receiving user input through the modified interface; and
the handheld device sending a control signal to the device according to the user input.
